(19) United States
(12) Patent Application Publication
(10) Pub. No.: US 2008/0165061 A1
(43) Pub. Date: Jul. 10, 2008

(54) CIRCULARLY POLARIZED ANTENNA

(75) Inventors: Shih-Chieh Lin, Kaohsiung Hsien (TW); Hua-Ming Chen, Kaohsiung City (TW); Yang-Kai Wang, Kaohsiung Hsien (TW)

Correspondence Address: DARBY & DARBY P.C., P.O. BOX 770, Church Street Station, New York, NY, 10008-0770, US

(73) Assignee: ADVANCED CONNECTION TECHNOLOGY INC., Taipei Hsien (TW)

(21) Appl. No.: 11/968,276

(22) Filed: Jan. 2, 2008

(30) Foreign Application Priority Data
Jan. 5, 2007 (TW) 096100444

(51) Int. Cl. H01Q 1/38; H01Q 9/04

(52) U.S. Cl. 343/700 MS

(57) ABSTRACT

A circularly polarized antenna includes first and second dielectric substrates, a grounding element, a feeding element, a coupling element, and a close-loop radiating element. The grounding element is formed on a first surface of the first dielectric substrate. The feeding element is formed on a second surface of the first dielectric substrate. The second dielectric substrate is disposed on the second surface of the first dielectric substrate and overlaps the feeding element. The coupling element is formed on the second dielectric substrate. The close-loop radiating element is formed on the second dielectric substrate.

### BACKGROUND OF THE INVENTION

1. Field of the Invention

This invention relates to a circularly polarized antenna, more particularly to a circularly polarized antenna that is suitable for application to mobile communications devices.

2. Description of the Related Art

The increase in market share of smart handsets makes incorporation of global positioning system (GPS) functionalities, such as receiving of GPS signals, onto the smart handsets inevitable. Thus, integration of a circularly polarized antenna and the smart handset is a significant consideration since the GPS signals can only be efficiently received using the circularly polarized antenna.

Numerous circularly polarized antennas of single-fed or dual-fed type have been proposed in the art. The single-fed circularly polarized antenna, however, has the disadvantages of having a narrow operating frequency bandwidth and not being easy to adjust for impedance matching. The dual-fed circularly polarized antenna, on the other hand, has the disadvantages of being bulky and heavy.

The aforementioned conventional circularly polarized antennas are therefore not suitable for integration with the smart handsets.

### SUMMARY OF THE INVENTION

Therefore, the object of the present invention is to provide a circularly polarized antenna that can overcome the aforesaid drawbacks of the prior art.

According to the present invention, a circularly polarized antenna comprises first and second dielectric substrates, a grounding element, a feeding element, a coupling element, and a close-loop radiating element. The first dielectric substrate has opposite first and second surfaces. The grounding element is formed on the first surface of the first dielectric substrate. The feeding element is formed on the second surface of the first dielectric substrate. The second dielectric substrate has a first surface that is disposed on the second surface of the first dielectric substrate and that overlaps a portion of the feeding element, and a second surface that is opposite to the first surface of the second dielectric substrate. The coupling element is formed on the second surface of the second dielectric substrate. The close-loop radiating element is formed on the second surface of the second dielectric substrate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a circularly polarized antenna according to the present invention;

FIG. 2 is a schematic top view of FIG. 1;

FIG. 3 is a plot illustrating a return loss of the preferred embodiment;

FIG. 4 is a Smith chart illustrating experimental results of the preferred embodiment;

FIG. 5 is a plot illustrating a radiation pattern of the preferred embodiment on the xz plane;

FIG. 6 is a plot illustrating a radiation pattern of the preferred embodiment on the xy plane;

FIG. 7 is a plot illustrating an axial ratio of the preferred embodiment;

FIG. 8 is a plot illustrating an antenna gain of the preferred embodiment; and

FIG. 9 is a schematic view to illustrate a modified embodiment of the preferred embodiment.

### DETAILED DESCRIPTION OF THE PREFERRED EMBODIMENT

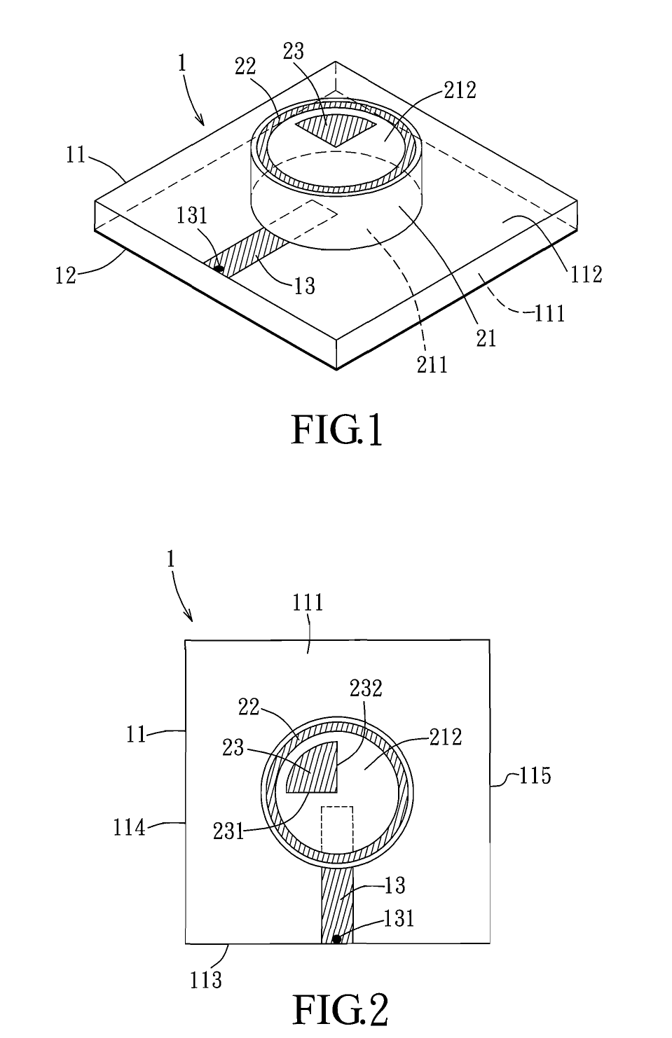

Referring to FIGS. 1 and 2, the preferred embodiment of a circularly polarized antenna 1 according to this invention is shown to include first and second dielectric substrates 11, 21, a grounding element 12, a feeding element 13, a coupling element 23, and a close-loop radiating element 22.

The circularly polarized antenna 1 of this embodiment is designed to operate at a center frequency of 2700 MHz.

The first dielectric substrate 11 is generally square in shape, and has opposite first and second surfaces 111, 112. In this embodiment, the first dielectric substrate 11 has dimensions of 30 millimeters by 30 millimeters. Preferably, the first dielectric substrate 11 is a FR-4 substrate.

In an alternative embodiment, the first dielectric substrate 11 is circular in shape.

The grounding element 12 is generally square in shape and is formed on the first surface 111 of the first dielectric substrate 11. In this embodiment, the grounding element 12 has the same dimensions as the first dielectric substrate 11.

In an alternative embodiment, the grounding element 12 is circular or triangular in shape.

The feeding element 13 is generally rectangular in shape, is formed on the second surface 112 of the first dielectric substrate 11, and extends from a first side 113 of the first dielectric substrate 11 toward a center of the second surface 112 of the first dielectric substrate 11. In this embodiment, the feeding element 13 has dimensions of 13.5 millimeters by 3 millimeters. Preferably, the feeding element 13 is a metallic strip, such as a micro-strip.

In an alternative embodiment, the feeding element 13 is L-shaped, cross-shaped, or X-shaped.

In yet another embodiment, the feeding element 13 is a coplanar waveguide (CPW), a slot feed, or a slot line.

The circularly polarized antenna 1 further includes a feeding point 131 provided on the feeding element 13 and disposed proximate to the first side 113 of the first dielectric substrate 11.

The second dielectric substrate 21 is cylindrical in shape, has a first surface 211 that is disposed on the second surface 112 of the first dielectric substrate 11 and that overlaps a portion of the feeding element 13, and a second surface 212 opposite to the first surface 211 of the second dielectric substrate 21. In this embodiment, the second dielectric substrate 21 has a height of 3.3 millimeters and a radius of 7.4 millimeters. Preferably, the second dielectric substrate 21 is made from a ceramic material.

In an alternative embodiment, the second dielectric substrate 21 is cubic in shape.

In yet another embodiment, the second dielectric substrate 21 is a FR-4 substrate.

The coupling element 23 is sector-shaped, has opposite sides 231, 232, and is formed on the second surface 212 of the second dielectric substrate 21. In this embodiment, each of the opposite sides 231, 232 of the coupling element 23 has a dimension of 5 millimeters. Preferably, the opposite sides 231, 232 of the coupling element 23 define an angle of 90 degrees therebetween.

In an alternative embodiment, as illustrated in FIG. 9, the coupling element 23 is arc-shaped.

In yet another embodiment, the coupling element 23 is rectangular, square, triangular, or semi-circular in shape.

It is noted that when the shape of the feeding element 13 is modified, the shape of the coupling element 23 may be modified accordingly to thereby reduce a physical size, lessen a capacitance effect, and decrease a sensitivity of the coupling element 23.

The close-loop radiating element 22 is ring-shaped, is formed on the second surface 212 of the second dielectric substrate 21, and surrounds the coupling element 23. In this embodiment, the close-loop radiating element 22 has an outer radius of 7 millimeters and an inner radius of 6 millimeters.

In an alternative embodiment, the close-loop radiating element 22 is rectangular, square, triangular, or elliptical in shape.

It is noted herein that, in this embodiment, since the coupling element 23 is formed on the second dielectric substrate 21 such that the coupling element 23 is disposed closer to a second side 114 of the first dielectric substrate 11 rather than to a third side 115 of the first dielectric substrate 11, the circularly polarized antenna 1 of this embodiment is a right hand circularly polarized (RHCP) antenna. Alternatively, when a left hand circularly polarized (LHCP) antenna is desired, the coupling element 23 may be simply formed on the second dielectric substrate 21 such that the coupling element 23 is disposed closer to the third side 115 of the first dielectric substrate 11 rather than to the second side 114 of the first dielectric substrate 11. Moreover, the circularly polarized antenna 1 of this invention may include an element (not shown) that is connected to the close-loop radiating element 22, and that is disposed inside or outside of the close-loop radiating element 22. Further, the coupling element 23 may be disposed outside of or on the close-loop radiating element 22.

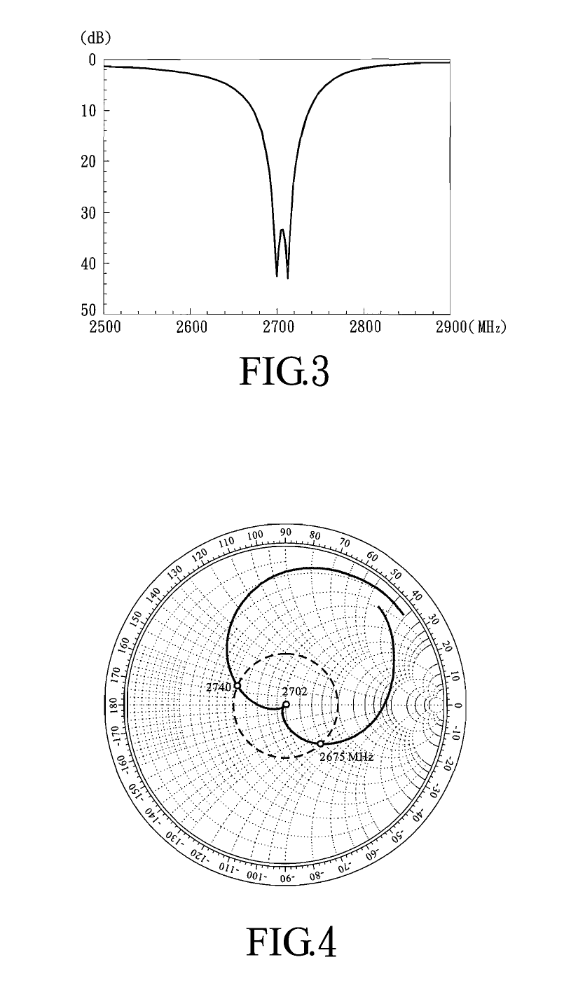

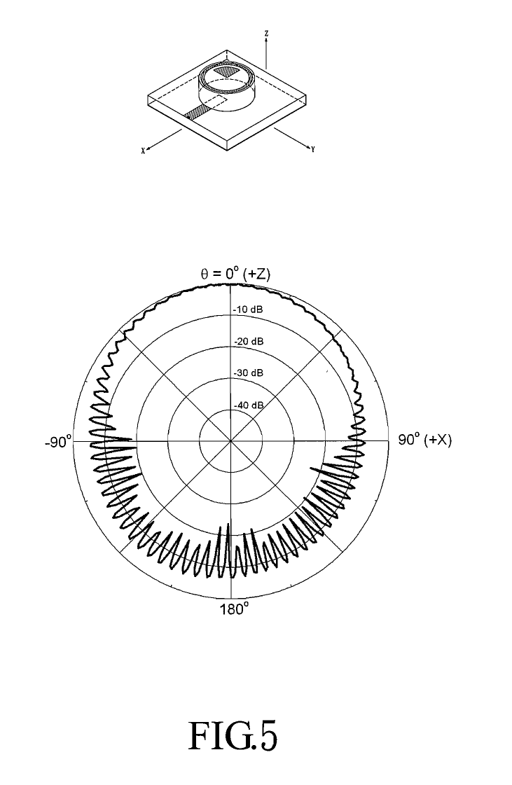

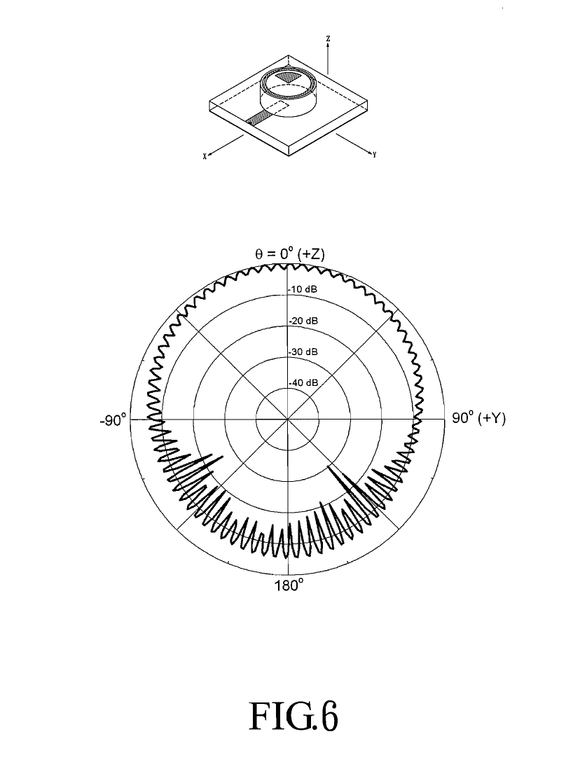

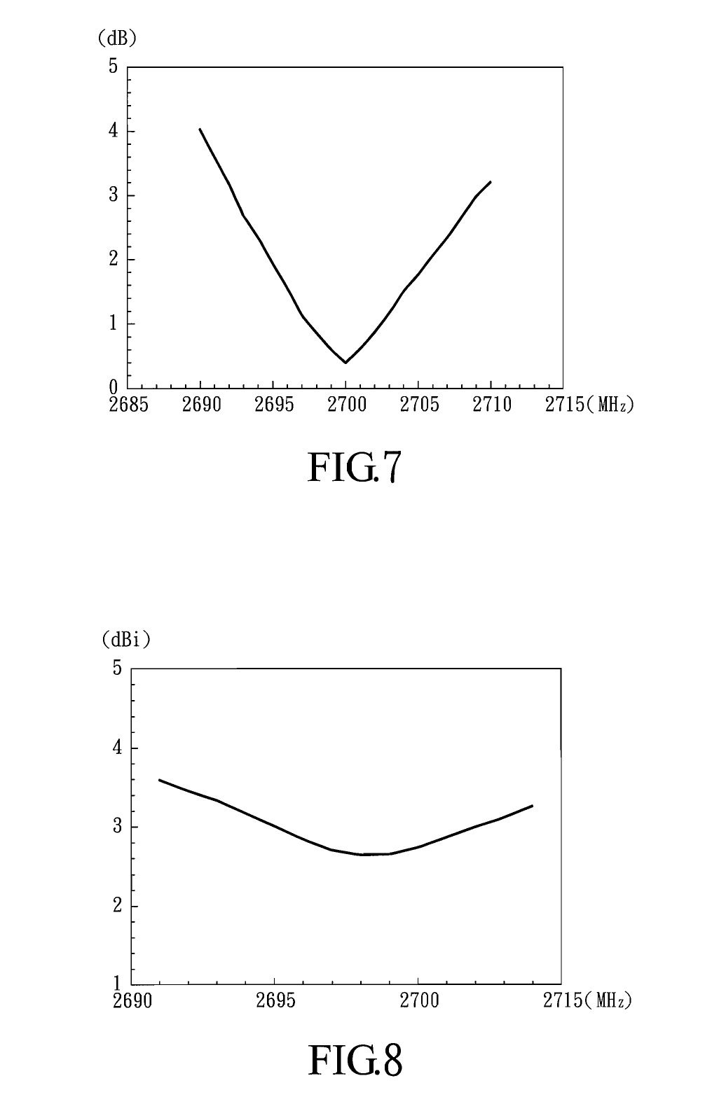

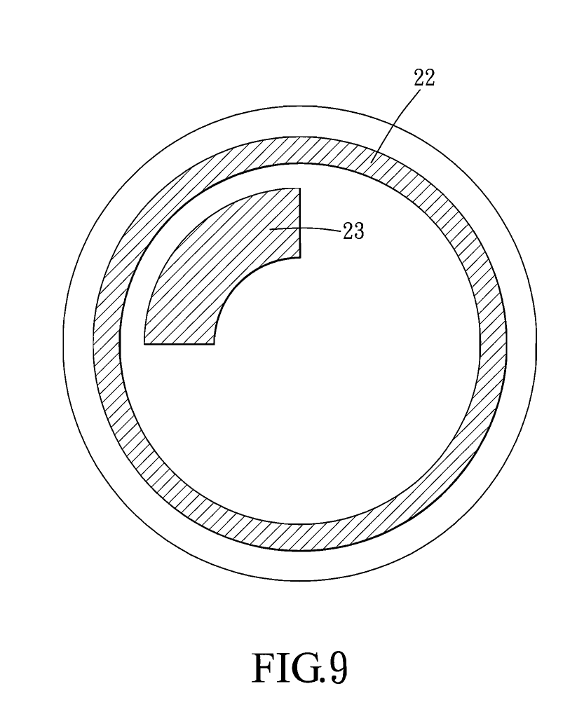

FIGS. 3 to 8 are plots from experimental results at the center frequency (i.e., 2700 MHz) of the circularly polarized antenna 1 of this invention. As illustrated in FIG. 3, the circularly polarized antenna 1 of this invention achieves an impedance bandwidth of approximately 65 MHZ (i.e. 2675 to 2740 MHz) for a return loss of −10 dB (i.e., VSWR≦2). Moreover, as illustrated in FIGS. 5 and 6, the circularly polarized antenna 1 of this invention achieves a half power beamwidth of 100 degrees for a ripple that ranges from 0 dB to 3 dB. Further, as illustrated in FIGS. 7 and 8, the circularly polarized antenna 1 of this invention achieves an axial ratio of less than 3 dB (e.g., 0.5 dB) and an antenna gain that varies between 2.5 dBi and 3.5 dBi.

It is noted that signals from a signal source (not shown) are fed to the circularly polarized antenna 1 of this invention through electromagnetic coupling between the feeding element 13, and the coupling element 23 and the close-loop radiating element 22. That is, there is no physical connection between the feeding element 13, and the coupling element 23 and the close-loop radiating element 22. Instead, the feeding element 13 generates an electric field radiation that radiates upwardly therefrom when the signal from the signal source, in the form of electric field energy, is transmitted therethrough. Moreover, the dimensions of the feeding element 13 may be simply adjusted for the purpose of impedance matching.

From the above description, since each of the first and second dielectric substrates 11, 21, the feeding element 13, the coupling element 23, and the close-loop radiating element 22 has a relatively small physical size, and since there is no physical connection between the feeding element 13, and the coupling element 23 and the close-loop radiating element 22, the circularly polarized antenna 1 of this invention is suitable for application to mobile communications devices, such as a smart handset.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A circularly polarized antenna, comprising:
a first dielectric substrate having opposite first and second surfaces;
a grounding element formed on said first surface of said first dielectric substrate;
a feeding element formed on said second surface of said first dielectric substrate;
a second dielectric substrate having a first surface that is disposed on said second surface of said first dielectric substrate and that overlaps a portion of said feeding element, and a second surface that is opposite to said first surface of said second dielectric substrate;
a coupling element formed on said second surface of said second dielectric substrate; and
a close-loop radiating element formed on said second surface of said second dielectric substrate.

2. The circularly polarized antenna as claimed in claim 1, wherein said close-loop radiating element surrounds said coupling element.

3. The circularly polarized antenna as claimed in claim 1, wherein said first dielectric substrate is generally rectangular in shape.

4. The circularly polarized antenna as claimed in claim 1, wherein said first dielectric substrate is a FR-4 substrate.

5. The circularly polarized antenna as claimed in claim 1, wherein said grounding element is generally rectangular in shape.

6. The circularly polarized antenna as claimed in claim 1, wherein said feeding element is a metallic strip.

7. The circularly polarized antenna as claimed in claim 1, wherein said second dielectric substrate is cylindrical in shape.

8. The circularly polarized antenna as claimed in claim 1, wherein said second dielectric substrate is made from a ceramic material.

9. The circularly polarized antenna as claimed in claim 1, wherein said coupling element is sector-shaped.

10. The circularly polarized antenna as claimed in claim 1, wherein said close-loop radiating element is ring-shaped.
